(19) United States
(12) Patent Application Publication
(10) Pub. No.: US 2005/0125283 A1
(43) Pub. Date: Jun. 9, 2005

(54) Methods for enhancing career analysis

(76) Inventors: David P. Fan, St. Paul, MN (US); Regis S. Fan, Boulder, CO (US)

Correspondence Address: Schwegman, Lundberg,;Woessner & Kluth, P.A., P.O. Box 2938, Minneapolis, MN, 55402, US

(21) Appl. No.: 11/031,606

(22) Filed: Jan. 7, 2005

Related U.S. Application Data
(63) Continuation of application No. 09/521,751, filed on Mar. 9, 2000, now abandoned.

(51) Int. Cl. G06F 17/60

(52) U.S. Cl. 705/11; 705/10; 705/9

(57) ABSTRACT

Systems, methods, and structures are described that enhance career analysis. Various embodiments include a storage system of information in which the past histories of people are organized so that users of the system can predict the likelihood of a future outcome such as salary earned upon the completion of an activity such as a job training course. Various embodiments can be used for other predictions such as the types of job and/or training history which are most likely to lead to a particular career and other characteristics of organizations and population such as buying patterns and the quality of educational institutions.

### CROSS-REFERENCE TO RELATED APPLICATIONS

The present application is a continuation of U.S. Ser. No. 09/521,751, filed Mar. 9, 2000, which is incorporated herein by reference in its entirety.

### TECHNICAL FIELD

The technical field relates generally to predicting. More particularly, it pertains to enhancing career analysis so as to predict a desired state.

### COPYRIGHT NOTICE—PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawing attached hereto: Copyright ® 1999, 2000, All Rights Reserved.

### BACKGROUND

One useful type of information for people planning career paths is knowledge about the likely consequences of actions such as acquiring more education and training. At present, information is available about the types of background necessary for different types of jobs. Public guides, such as those available from the U.S. Department of Labor (1998/1999), and private guides, such as though from J.G. Ferguson Pub. Co. (1997), list a large number of jobs and the qualifications needed for them.

Presently, no career resources exist that inform a person about the likely outcomes of different decisions taken at various times in life. For instance, students in schools and job training institutions do not have convenient ways to assess the jobs that they are likely to hold in the later years of their lives. Such analysis is difficult and inexact, and is reduced to a haphazard decision-making process.

Similar haphazard decision-making processes also occur with sophisticated employers. No resources exist for employers to use in order to analyze events that a person could have taken to reach a particular job. The existence of such resources would permit employers to know the types of background most advantageous for different jobs.

Thus, what is needed are systems, methods, and structures to enhance career analysis so as to predict a desired state.

### SUMMARY

Systems, methods, and structures to support enhanced career analysis are discussed. An illustrative aspect includes a system for enhancing career analysis. The system comprises a collection of resumes that includes at least one resume, a World Wide Web that allows access to the collection of résumés, and a career-analysis engine that interfaces with the World Wide Web to access the collection of résumés so as to enhance career analysis. In one illustrative aspect, the career-analysis engine includes an electronic database that permits the user to filter for various types of information. One type of information includes the likely career outcomes given particular decisions taken earlier in life. Another type of information includes the likely paths that lead from a past career to potential future careers. Yet another type of information includes population characteristics such as buying patterns.

Another illustrative aspect includes a method for enhancing career analysis. The method comprises storing a history of at least one person, processing the history, and determining a probability based upon the history of at least one person so as to enhance career analysis.

Another illustrative aspect includes a data structure for enhancing career analysis. The data structure comprises a data member résumés to represent a history of at least one person. The data member résumés includes at least one data member state to represent a state in the history of a person. The data member state includes a data member identifier to identify the person, a data member begin to represent a beginning date for the state, and a data member end to represent an ending date for the state.

### BRIEF DESCRIPTION OF THE DRAWINGS

FIG. 1 is a block diagram of a system according to one aspect of the present invention.

FIG. 2 is a block diagram of a system according to one aspect of the present invention.

FIG. 3 is a process diagram of a method according to one aspect of the present invention.

FIG. 4 is a structure diagram of a data structure according to one aspect of the present invention.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

The embodiments of the present invention focus on analyzing and storing information about the past histories of people. Such information can be mined to predict career outcomes, to predict which group of people are most likely to end up in particular jobs, and to predict other characteristics, such as buying patterns and the quality of educational institutions. The term “predict” means the inclusion of calculating a state as a result of study and analysis of available pertinent data. The term “state” means the inclusion of an event, an activity, or another characteristic of the person.

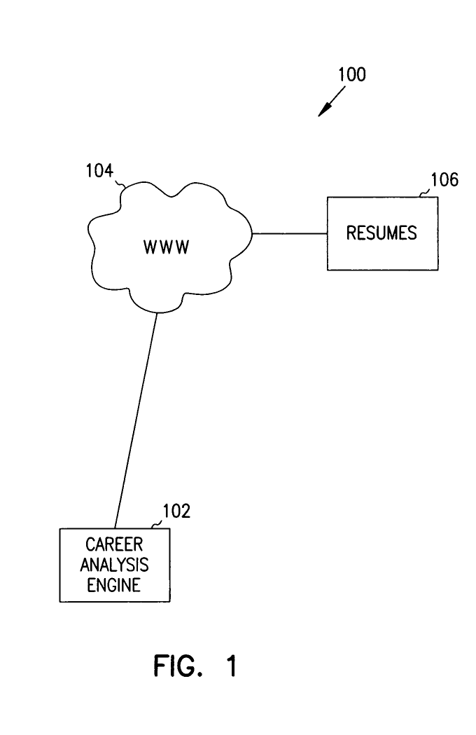

FIG. 1 is a block diagram of a system according to one aspect of the present invention. A system 100 includes a career-analysis engine 102. The career-analysis engine 102 includes software to analyze historical information of people, such as a résumé of a person. In on embodiment, the career-analysis engine 102 is adapted to predict a population time trend. The term “population time trend” means the inclusion of a set of states of people that is tracked through time. In one embodiment, the population time trend includes career analysis. In another embodiment, the population time trend includes evaluation of the quality of an institution, such as a university. In another embodiment, the population time trend includes buying and selling patterns. In another embodiment, the population time trend includes planning an urban infrastructure. In one embodiment, the career-analysis engine 102 includes a database.

The career-analysis engine 102 is adapted to interface the World Wide Web 104 via a network. In one embodiment, the network includes the Internet or the Internet 2. The World Wide Web 104 is adapted to interface with a collection of résumés 106 so as to allow access to the collection of résumés 106. In one embodiment, the collection of résumés 106 is stored on a server. The career-analysis engine 102 accesses the collection of résumés 106 through the World Wide Web 104. In one embodiment, the career-analysis engine 102 accesses the server through a browser. In one embodiment, the collection of résumés 106 is stored in at least one database.

In another embodiment, the system 100 includes a collection of transcripts. The World Wide Web 104 also interfaces to the collection of transcripts so as to allow access to the collection of transcripts. The career-analysis engine 102 can interface with the World Wide Web 104 to access the collection of transcripts. In one embodiment the collection of transcripts is stored in at least one database.

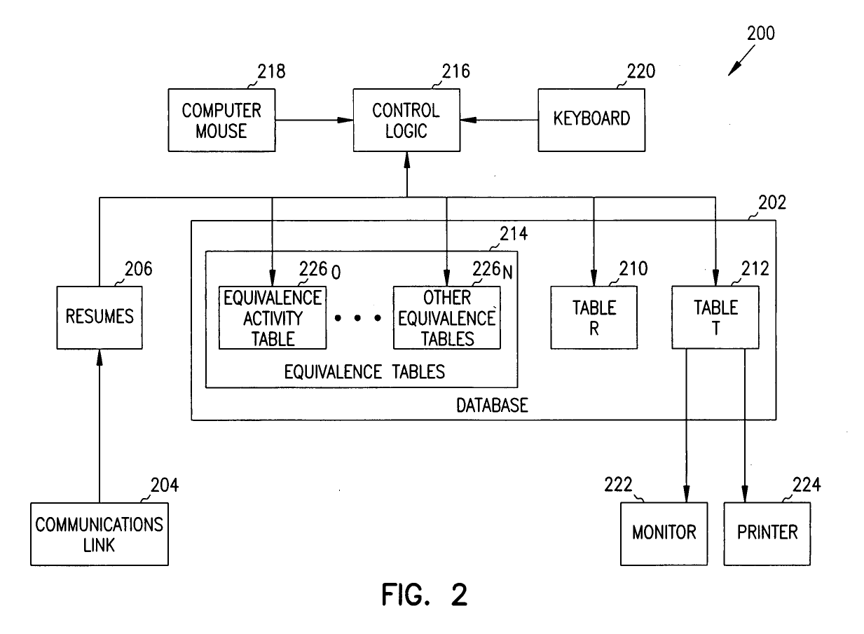

FIG. 2 is a block diagram of a system according to one aspect of the present invention. A system 200 includes a communication link 204. In one embodiment, the communication link 204 includes the Internet. In another embodiment, the communication link 204 includes the Internet 2. The system 200 includes résumés 206. Résumés 206 are communicated on the communication link 204 to be input into the career-analysis engine 202. Résumés 206 include at least one résumé of at least one person.

The career-analysis engine 202 includes a résumé table 210. The résumétable 210 includes a plurality of records. Each record in the résumé table 210 includes a plurality of fields. Each field in a record in the résumé table 210 is filled from at least one résumé of at least one person.

The career-analysis engine 202 includes a temporary table 212. The temporary table 212 includes a plurality of records. Each record in the temporary table 212 includes a plurality of fields. Each field in a record in the temporary table 212 is derived from at least one record of the plurality of records of the résumé table 210.

The career-analysis engine 202 includes a plurality of equivalence tables 214. The plurality of equivalence tables 214 includes equivalence activity table 226₀ and other equivalence tables 226_{N}, such as an equivalence skill table. In one embodiment, the equivalence activity table 226₀ includes a code field and a description field. The code field includes a numeric code for an activity. The description field includes a textual description for the numeric code associated with the activity.

The system 200 includes a controller 216 that includes control logic to control the career-analysis engine 202. The system 200 also includes a plurality of input devices, such as a computer mouse 218 and a keyboard 220. These input devices are coupled to the controller 216. The system 200 also includes a plurality of output devices, such as a monitor 222 and a printer 224. These output devices are adapted to output information from the temporary table 212.

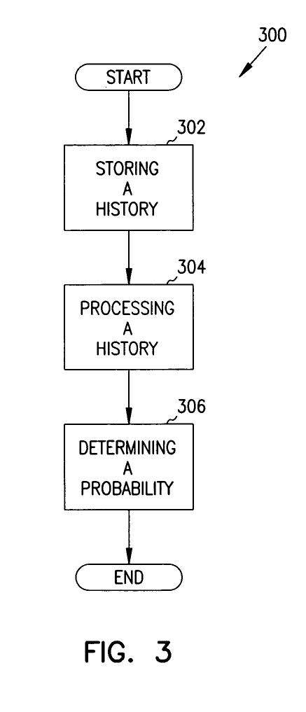

FIG. 3 is a process diagram of a method according to one aspect of the present invention. A process 300 discusses a method for enhancing career analysis. The process 300 includes an act 302 for storing a history of at least one person. Such history may be obtained from a person's résumé, transcript, or both. A person's résumé includes a number of entries. Each entry may include a state, a start date, and an end date. In one embodiment, the history of the person includes a collection of states. In another embodiment, the history of the person includes at least one event, a compensation level, or both. The state includes a job, volunteer work, training, etc. Training includes job-training courses. A path is a sequence of states. In one embodiment, the history includes a plurality of paths. The compensation level includes a salary, benefits, etc.

In one embodiment, the act 302 includes mining a database for the history of the person. In another embodiment, the act 302 stores the history of the person in a database. In another embodiment, the act 302 stores a history of a person of interest. The term “person of interest” means the inclusion of a person whose career will undergo analysis using the process 300.

In another embodiment, the act 302 includes creating a database, collecting data from at least one database on the World Wide Web, processing the data, and storing the data in the created database. In one embodiment, the data from at least one database on the World Wide Web includes at least one résumé that is posted by a job seeker. In one embodiment, the act 302 includes organizing the history of the person.

The process 300 includes an act 304 for processing the history.

The process 300 includes an act 306 for determining a probability based upon the history of at least one person. In one embodiment, the act 306 includes determining the probability of at least one compensation level depending on a completion of a state or a sequence of states. In another embodiment, the act 306 includes determining the probability of reaching a career based upon at least one job and at least one training course. In another embodiment, the act 306 includes determining the probability of at least one characteristic of an organization. A characteristic of the organization includes quality. The organization includes an educational institution, such as a university. In another embodiment, the act 306 includes determining the probability of reaching a desired career by a person of interest based upon at least one state in the history of the person of interest. In another embodiment, the act 306 includes determining the probability of each path of the plurality of paths for reaching a desired career from a past career. In yet another embodiment, the act 306 includes determining the probability of at least one characteristic of a population. The characteristic of the population includes a buying pattern.

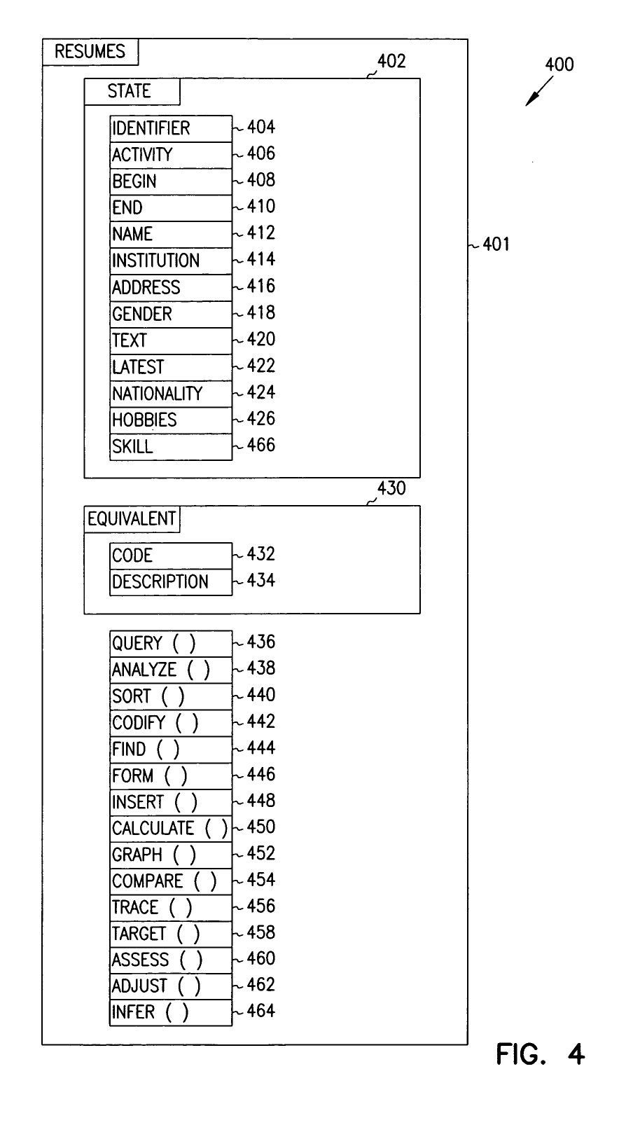

FIG. 4 is a structure diagram of a data structure according to one aspect of the present invention. A data structure 400 includes a data member résumés 401. The data member résumé 401 represents a history of at least one person. The data member résumés 401 includes at least one data member state 402. The data member state 402 represents a state in the history of the person, such as an event in a résumé of a person.

In an exemplary embodiment, The data structure 400 is instantiated by creating an electronic database called “RésuméDatabase” that contains data from résumés submitted by job seekers to the World Wide Web. These résumés are often stored in other databases. A résumé typically includes a series of states describing a person's state commencing at a beginning date and ceasing at an ending date. This sequence of states gives a history of that person. For illustrative purposes only, a fragment of Jane Doe's history might include the following states:

| | | |
|---|---|---|
| Name: | Jane Doe | |
| Address | 1 Elm Street, QRS City, | |
| | New York | |
| 1994 | ABC College, DEF City | Received B.A. degree in |
| | | Biology |
| 1994-1996 | HIJ Company, KLM City | Laboratory technician in |
| | | bacteriology |
| 1996-present | NOP Company, QRS City | Quality control specialist in |
| | Skill: gas chromatography | immunology |

Returning to FIG. 4, the data member state 402 includes a number of data members. A data member identifier 404 uniquely identifies a person. A data member activity 406 represents an activity of the state. A data member begin 408 represents the beginning date for the state. A data member end 410 represents the end date for the state. A data member name 412 represents a name of the person. A data member institution 414 represents an institution. A data member address 416 represents an address. A data member gender 18 represents a gender of the person. A data member text 420 represents the original text describing the state. A data member latest 422 represents the latest activity in the history of the person. A data member nationality 424 represents the nationality of the person. A data member hobbies 426 represents at least one hobby of the person. A data member skill 466 represents at least one skill of the person.

In the exemplary embodiment discussed hereinbefore, the data from a résumé would be placed in a table “R” of RésuméDatabase with the following fields:

| | |
|---|---|
| R_ID = | unique identifying number for the person |
| R_Name = | name of the person |
| R_BeginDate = | beginning date of the status |
| R_EndDate = | ending date of the status |
| R_Text = | text given by the résumé writer |
| R_State_Activity = | code equivalence for the activity deduced from |
| | R_Text |
| R_State_Institution = | code equivalence for the institution deduced from |
| | R_Text |
| R_State_Address = | code equivalence for the address deduced from |
| | R_Text |
| R_State_Sex = | code equivalence for male or female |
| R_State_Skill = | code equivalence for skill |
| . | |
| . | |
| . | |
| R_State_Final = | code equivalence for the final status deduced from |
| | R_Text |

In addition to the status conditions of activity, institution, and address given above, there are other status values such as sex, nationality, skills, and hobbies of the person up to the final type of useful status, R_State_Final.

Returning to FIG. 4, in one embodiment, the data member institution 414 includes a data member courses, a data member grades, and a data member average. The data member courses includes at least one course taken by the person at the institution. The data member grades includes at least one grade for at least one course taken by the person at the institution. The data member average includes a grade point average for the person at the institution.

In one embodiment, each of the data members of the data member state 402 includes a code that is numerically indicative of the data that the data members contain. For example, the data member activity 406 includes a code that identifies the activity of the state; the data member institution 414 includes a code that identifies the institution; the data member address includes a code that identifies the address; the data member gender includes a code that identifies the gender of the person; and the data member skill includes a code that identifies a particular skill of the person.

In one embodiment, the data member text 420 is adapted from an entry on a résumé posted on the World Wide Web. In one embodiment, the data structure 400 is adapted to be at least one table stored in a database.

In one embodiment, a content of each of the data members of the data member state 402 except for the data member identifier 404 is derived from the text describing the state. For example, a content of the data member activity is adapted to derive from the text; a content of the data member institution is adapted to derive from the text; a content of the data member address is adapted to derive from the text; a content of the data member gender is adapted to derive from the text; and a content of the data member latest is adapted to derive from the text.

The data member résumés 400 also includes at least one data member equivalence 430. The data member equivalence 430 represents a data structure for a conversion between textual description and a code. Thus, the data member equivalence 430 represents a codification. The data member equivalence 430 includes a data member code to represent a code, and a data member description to represent a textual description of the code. In one embodiment, the data member equivalence 430 is instantiated to form a plurality of instantiations to contain codification for data members that include the data member activity, the data member institution, the data member address, and the data member gender.

In the exemplary embodiment discussed hereinbefore, using the above Jane Doe's history for illustrative purposes only, a record for Jane Doe as the 100^{th} person in Table R includes:

| | |
|---|---|
| R_ID = | 100 (referring to the 100th person) |
| R_Name = | Jane Doe |
| R_BeginDate = | 1994 |
| R_EndDate = | 1994 |
| R_Text = | ABC College, DEF City Received B.A. degree in |
| | Biology |
| R_State_Activity = | 123 (code equivalence for bachelor's degree in |
| | biology) |
| R_State_Institution = | 456 (code equivalence for ABC College) |
| R_State_Address = | 789 (code equivalence for DEF City) |
| R_State_Sex = | F (code equivalence for female) |
| R_State_Skill = | Null |
| . | |
| . | |
| . | |
| R_State_Final = | 1011 (code equivalence for final status) |

Value R_State_Activity is assigned by looking in table “EquivActivity” in database RésuméDatabase. Table EquivActivity is one in a group of tables called “Equivalence Tables” with two fields:

| | |
|---|---|
| E_Code = | code equivalence |
| E_Desc = | text description of the corresponding code equivalence |

For the example above, R_State_Activity is assigned 123 because table EquivActivity has this record:

| | |
|---|---|
| E_Code = | 123 |
| E_Desc = | bachelor's degree in biology |

For jobs, the E_Code of a job and hence the R_State_Activity for that job is the number assigned in the U.S. Department of Labor's Dictionary of occupational titles (1991). Other equivalence tables in RésuméDatabase would be used to look up code equivalences for R_State_Institution, R_State_Address, R_State_Sex (based on first name), etc.

The collection of R_Text fields for an individual includes all the original information in the résumé. The R_Text fields are included in Table R so that other status fields can be created or modified using their text information. In this way, the database designer can create and change R-State fields as needed. For example, the R_State_Activity field above was assigned to be 123 for any bachelor's degree in biology, such as either Bachelor of Arts (BA) or Bachelor of Science (BS). If it is found to be useful at a later time, the information in the R_Text field can be used to change the code equivalence in the R_State_Activity field so that it corresponds to a BA degree and not a BS degree.

Returning to FIG. 4, the data member résumés 400 also optionally includes a number of method members. A method member query( ) 436 represents a method for obtaining a desired state from a user for analysis. In one embodiment, the desired state includes reaching a profession. In another embodiment, the desired state includes obtaining a compensation level for a profession. In another embodiment, the desired state includes a number of desired states.

In the exemplary embodiment discussed hereinbefore, when the Table R is constructed, the user can query the database RésuméDatabase to determine the likely consequences of having a particular status. Thus, the computer may ask: “What condition do you want to consider?” The user might respond: “Getting a bachelor's degree in biology.”

Returning to FIG. 4, the data structure 400 includes a method member sort( ) 440 for sorting through each instantiation of the data member state 402. The method member sort( ) 440 clusters each instantiation based on the content of the data member identifier 404. Thus, multiple clusters may be formed. The method member sort( ) 440 also sorts each cluster in chronological order based on the date stored in the data member begin 408.

In the exemplary embodiment discussed hereinbefore, after the user requests an analysis be performed for getting a bachelor's degree in biology, the computer sorts through all records in Table R, and clusters all records with the same R_ID. Within each cluster with the same R_ID, the computer then sorts through all records in forward chronological order by R_Begin_Date.

Returning to FIG. 4, the data structure 400 includes a method member find( ) 444 for stepping through each instantiation of the data member state 402 to find an instantiation of the data member state 402 with a data member activity with a code that matches the code for the desired state. The first instantiation with a code that matches the code for the desired state is defined to be an anchor record. A subsequent instantiation that has a code that matches the code for the desired state is defined to be a current record.

In one embodiment, the method member find( ) 444 redefines the anchor record. The method member find( ) 444 redefines the anchor record if the following occurs: (1) the method member find( ) 444 encounters an instantiation of the data member state 402 that includes a data member activity that includes a code that does not match the code for the desired state. (2) Subsequently, the method member find( ) 444 finds another instantiation of the data member state 402 that includes a data member activity that includes a code that matches the code for the desired state. This latest instantiation of the data member state 402 is redefined to be the anchor record.

In another embodiment, the anchor record includes an anchor date. The anchor date is assigned from either the data member begin or the data member end of the data member state 402 that has been defined as the anchor record.

The data structure 400 includes a method member form( ) 446 for forming an instantiation of a temporary data structure. The temporary data structure includes a number of data members. A data member identifier stores a content of the data member identifier of the current record. A data member activity stores a content of the data member activity of the current record. A data member begin stores a difference between a content of the data member begin of the current record and a content of the data member begin of the anchor record. A data member end stores a difference between a content of the data member begin of the current record and a content of the data member begin of the anchor record. A data member institution stores a content of the data member institution of the current record. A data member address stores a content of the data member address of the current record. A data member gender stores a content of the data member gender of the current record. In addition, a data member latest stores a content of the data member latest of the current record.

The data structure 400 includes a method member insert( ) 448 for inserting an instantiation of the temporary data structure into a temporaries data structure. The temporaries data structure includes a collection of the temporary data structures. The method member insert( ) 448 inserts the instantiation of the temporary data structure when the data member identifier of the current record matches the data member identifier of the anchor record.

In the exemplary embodiment discussed hereinbefore, after the sorting as discussed hereinbefore, the computer looks up “bachelor's degree in biology” in a table EquivActivity and finds the value of 123. The computer then steps through Table R until a record is found with R_State_Activity=123. This record is called the “anchor” record and its fields are called anchor fields. The computer then examines the next record called the “current” record. If the R_ID of the current record is the same as the anchor R_ID, then a record is inserted into temporary Table T with these fields:

| | |
|---|---|
| T_ID = | current R_ID |
| T_IntervalBegin = | current R_BeginDate - anchor R_BeginDate |
| T_IntervalEnd = | current R_EndDate - anchor R_BeginDate |
| T_State_Activity = | current R_State_Activity |
| T_State_Institution = | current R_State_Institution |
| T_State_Address = | current R_State_Address |
| T_State_Sex = | current R_State_Sex |
| . | |
| . | |
| . | |
| T_State_Final = | current R_State_Final |

These insertions continue into Table T with each increment in Table R leading to a new row in Table T until a different R_ID is encountered. At this point the computer makes no entries until next record is found with R_State_Activity=123. This record becomes the new anchor record and entries are again entered into Table T until R_ID changes. This process continues through the entire R database.

Returning to FIG. 4, the data structure 400 includes a method member calculates 450 for calculating a probability of an occurrence of the desired state within a desired time frame. Such calculation is based on each instantiation of the temporary data structure. In the embodiment in which the desired state includes reaching a profession, the chronological order is backward so as to allow the method member calculate( ) 450 to calculate a distribution of states in the history that lead to the profession.

The data structure 400 includes a method member graph( ) 452 for producing a graph that graphs the probability of the occurrence of the desired state within a desired time frame. In one embodiment, the graph includes a slider bar.

In the exemplary embodiment discussed hereinbefore, after the formation of the Table T as discussed above, the Table T contains a list of all activities occurring after the anchor activity as well as the time intervals between the later activities and the anchor activity. The user can access the data in Table T in a number of different ways. For instance, the computer can ask: “Do you want to look at jobs you are likely to hold?” If the user answers affirmatively, the computer would ask: “How many years later do you want to look?” If the user answers “5 years,” the computer counts, for each T_State_Activity code equivalence, the number of records for which 5 years is inside the interval T_IntervalBegin and T_IntervalEnd. The computer then graphs number of records against T_State_Activity. The T_State_Activity axis would not give the code equivalence of T_State_Activity but rather a short phrase like “technician” describing the corresponding job.

Returning to FIG. 4, the data structure 400 includes a method member compare( ) 454 for comparing the data member institution of each instantiation of the data member state 402. Such comparison allows an institution to evaluate the quality of the institution. In one embodiment, the method member compare( ) 454 can be executed if the desired state includes obtaining a compensation level and reaching a profession.

The data structure 400 includes a method member trace( ) 456 for tracing the data member address of each instantiation of the data member state so as to allow an urban planner to plan an urban infrastructure. In one embodiment, the method member trace( ) 456 can be executed if the desired state includes a desired population trend.

The data structure 400 includes a method member target( ) 458 for analyzing the data member name, the data member address, and the data member hobbies of each instantiation of the data member state. Such analysis allows at least one of a good and a service to be marketed to a desired consumer population. In one embodiment, the method member target( ) 458 can be executed if the desired state includes a desired consumer population.

The data structure 400 includes a method member assess( ) 460 for assessing whether the data member résumé 401 is representative of a target population. The method member assess( ) 460 assesses by comparing the data member résumé 401 to data that is known to represent the target population.

In the exemplary embodiment discussed hereinbefore, the representativeness of the database for a target population is assessed by comparing R_State_fields in Table R with demographic characteristics known to be representative of the target population. The method to assess representativeness is the same as the one used for public opinion surveys. See Groves, Biemer, Lyberg, Massey, Nicholas, and Waksberg (1988), where the comparison is made to items from governmental census records for such features as sex and geographic address.

Returning to FIG. 4, the data structure 400 includes a method member adjusts 462 for adjusting the probability for the occurrence of the desired state. Such adjustment occurs when the data member résumé 401 is not representative of a target population.

In the exemplary embodiment discussed hereinbefore, the computer further weights the counts so that if an activity in the representativeness computation described above is low by 50 percent then the count is multiplied by the reciprocal of 50 percent or 2. The user can select different anchor T_State_Activity values and examine his or her likely outcomes as a basis for making informed choices about key career decisions.

The data structure 400 includes a method member infer( ) 464 for inferring a date for either the data member begin or the data member end of the data member state. Such inference of a date may be needed when the history of the person does not include a date for a particular state.

In one embodiment, an exemplary instantiation of the data member state includes a data member skill that has a first desired code. The method member infer( ) 464 forms a first collection of instantiations. This first collection includes each instantiation of the data member state that has a data member skill with the first desired code. In the same embodiment, the exemplary instantiation of the data member state includes a data member identifier that has a second desired code. Next, the method member infer( ) 464 forms a second collection of instantiations. The second collection includes each instantiation of the data member state that has a data member identifier with the second desired code. Next, the method member infer( ) 464 forms a histogram based on the data member activity from the second collection. Next, the method member infer( ) 464 assigns a date for the data member begin of the exemplary instantiation of the data member state. This date is the date taken from a data member begin of the data member state from the second collection that has a highest frequency in the histogram. Therefore, this process infers a date for the data member begin from frequency analysis.

In the exemplary embodiment discussed hereinbefore, for some R_State_fields, R_BeginDate and R_EndDate might not be in the résumé. These dates, however, can be inferred from histories in Table R. For Jane Doe's history given above, the initial record corresponding to the last line includes:

| | |
|---|---|
| R_ID = | 100 (referring to the 100th person) |
| R_Name = | Jane Doe |
| R_BeginDate = | Null |
| R_EndDate = | 2000 (current date) |
| R_Text = | Skill: gas chromatography |
| R_State_Activity = | Null |
| R_State_Institution = | Null |
| R_State_Address = | Null |
| R_State_Sex = | F (code equivalence for female) |
| R_State_Skill = | 1213 (code equivalence for gas chromatography) |
| . | |
| . | |
| . | |
| R_State_Final = | Null |

To assign R_BeginDate for R_State_Skill, all records in Table R would be searched for all R_ID with R_State_Skill=1213. Among all records with these R_ID values, a search is made for all R_State_Activity values matching one of the R_State_Activity values with R_ID=100. These R_State_Activity values are called “matching R_State_Activity” values. The matching R_State_Activity field with the highest frequency is called the “consensus R_State_Activity.” The R_BeginDate for the above record for gas chromatography would be changed from null to the R_BeginDate of the record with R_ID=100 and R_State_Activity=the consensus R_State_Activity.

Returning to FIG. 4, the data structure 400 includes a method member analyze( ) 438 for analyzing a probability of at least one consequence for having the desired state.

The data structure 400 includes a method member codify( ) 442 for obtaining a code for a desired state. The method member codify( ) 442 obtains the code for the desired state by using at least one of the instantiations of the data member equivalence.

In the exemplary embodiment discussed hereinbefore, various modifications can be made without departing from the scope of the present invention. These modifications include:

(1) Alternate Inferred Dates: The anchor date includes R_BeginDate, and the assignment of the R_BeginDate for R_StateSkills also corresponds to an R_BeginDate. These dates can also be R_EndDate or another date such as an average computed from R_BeginDate and R_EndDate.

(2) Alternate Outcomes: In addition to the potential job prospects, the user can ask for the likely salaries at a specified later time for an anchor T_State_Activity. In response to such a question, the computer first looks in Table T to find the distribution of jobs that a person is likely hold at the later time. Then, the computer finds the likely salaries of people holding those jobs from a table giving salaries for various jobs and graphs the resulting salary distribution. The salary values can be adjusted for the amount of time in a particular type of job or the cost of living at various locations.

(3) Use to Assess Good Prospects for Jobs: Employers wishing to know the types of background most advantageous for particular jobs can use Table R in a different way. In this case, Table T above is altered so that the search from the anchor date is not forward in time but backward. This permits the employer to specify a job and then to look at the distribution of the types of activities at various times in the history which led to that job. This historical analysis permits the employer to target likely candidates to train or groom for a job.

(4) Use to Analyze Organizations, Goods and Services: Organizations offering training programs or other goods and services can use Table R to evaluate the quality of their offerings. For example, a school can use Table R to compare salary and job outcomes for their graduates with graduates of similar institutions. Favorable comparisons can be used in promotions such as advertising. Another use of Table R would be to trace population time trends such as those for the migration of people from one place to another. Migration time trends would be based on the R_State_Address field. Such information would be useful for town planners wishing to anticipate infrastructure needs. R_State_fields with non-employment information such as names, addresses, hobbies, and sex can be used to target audiences likely to purchase goods and services.

(5) Extraction of Information Based On More Than One Selected Activity: Table R can be used to search for outcomes and past histories based on more than one selected activity. In this case, Table T is constructed to include only those records in which the anchor R_ID is associated with all the selected activities.

(6) Student Transcript Data: Table R can also include information from schools and other training courses in which the R_State_fields would give grades received for different courses and other items such as grade point averages. The same method can be used to evaluate and adjust the information for representativeness as is described in the preferred embodiment.

(7) Alternate Table Structures: Table R and other tables in RésuméDatabase can be altered so that items are grouped differently. For instance, sex might be put into a separate table since it is a characteristic of an individual which does not change over time.

(8) Alternate Computer Displays: Besides letting the user give a single graph displaying the answer to the user-specified question, the computer can further include a slider bar under the graph on the computer screen showing the graph. The user can move the slider bar with a computer mouse to increase or decrease the time interval with the graph being continuously adjusted to show the progression of results over time.

### Conclusion

Systems, methods, and structures have been discussed to enhance career analysis. Whereas current career decision-making processes provide haphazard choices, the embodiments discussed hereinbefore provide a superior analysis with a desired level of precision. One reason that such analysis is enhanced is because such analysis is based on the professional histories of other people. Such professional histories can be derived from résumés or transcripts.

Although the specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used. Accordingly, the scope of the invention should only be determined with reference to the appended claims, along with the full scope of equivalences to which such claims are entitled.

1. A system for enhancing career analysis, the system comprising:
a collection of résumés that includes a plurality of résumés;
a network that allows access to the collection of résumés;
a career-analysis engine that interfaces with the network to access the collection of résumés so as to enhance career analysis by substantially simultaneously determining the probability of obtaining each of a variety of career outcomes or career goals based on analysis of career information from a plurality of the résumés of the collection of résumés; and
the career analysis engine including a report generator that produces a consolidated report indicating the determined probabilities for the variety of career outcomes.

2. The system of claim 1, wherein the network includes the Internet, wherein the Internet includes the World Wide Web, and wherein the career-analysis engine includes a database.

3. The system of claim 2, wherein the database includes a résumé table, wherein the résumé table includes a plurality of records, wherein each record includes a plurality of fields, wherein each field is derived from the at least one résumé.

4. The system of claim 3, wherein the database includes a temporary table, wherein the temporary table includes a plurality of records, wherein each record includes a plurality of fields, wherein each field is derived from at least one record of the plurality of records of the résumé table.

5. The system of claim 2, wherein the database includes a plurality of equivalence tables, wherein one of the plurality of equivalence tables includes an equivalence activity table, wherein the equivalence activity table includes a code and a description, wherein the code includes a numeric code for an activity, and wherein the description includes a textual description for the numeric code associated with the activity.

6. The system of claim 1, further comprising a collection of transcripts that includes at least one transcript, wherein the network allows access to the collection of transcripts, wherein the career-analysis engine interfaces with the network to access the collection of transcripts.

7. The system of claim 6, wherein the collection of résumés is stored in an electronic database, and wherein the collection of transcripts is stored in another electronic database.

8. The system of claim 1, further comprising a controller, wherein the controller includes a control logic to control the career-analysis engine.

9. The system of claim 8, further comprising a plurality of input devices coupled to the controller, wherein the plurality of input devices includes a mouse and a keyboard.

10. The system of claim 4, further comprising a plurality of output devices, wherein the plurality of output devices includes a monitor and a printer, wherein at least one of the monitor and the printer is adapted to output information from the temporary table.

11. A method for enhancing career analysis, the method comprising:
storing a history of at least one person;
processing the history of the at least one person; and
substantially simultaneously determining a probability of obtaining each of a variety of career outcomes or career goals based upon the history of the at least one person so as to enhance career analysis, wherein the determined probabilities are presented in a consolidated report.

12. The method of claim 11, wherein storing includes organizing the history of the at least one person.

13. The method of claim 11, wherein storing includes storing the history of the at least one person, wherein the history includes at least one state.

14. The method of claim 11, wherein determining the probability of obtaining at least one career outcome or goal includes determining the probability of obtaining at least one compensation level depending on a completion of at least one state.

15. The method of claim 14, wherein the compensation level includes a salary, and wherein the state includes at least one of a job training course, a skill, and a job.

16. The method of claim 11, wherein storing includes storing the history of the at least one person, wherein the history includes at least one job.

17. The method of claim 11, wherein storing includes storing the history of the at least one person, wherein the history includes at least one training course.

18. The method of claim 11, wherein determining the probability of at least one career outcome or goal includes determining the probability of reaching the career outcome or goal based upon the at least one of a job, a training course, and a skill.

19. The method of claim 11, wherein determining includes determining the probability of at least one characteristic of an organization, wherein the at least one characteristic includes quality, and wherein the organization includes an educational institution.

20. The method of claim 11, wherein determining includes determining the probability of at least one characteristic of a population, wherein the at least one characteristic includes a buying pattern.

21. The method of claim 11, wherein storing includes mining for the history of the at least one person.

22. The method of claim 11, wherein storing includes storing the history of the at least one person in a database.

23. The method of claim 11, wherein storing includes storing the history of the at least one person, wherein the history of the at least one person includes a history of a person of interest, wherein the history of the person of interest includes at least one state, and wherein determining the probability of obtaining at least one career outcome or goal includes determining the probability of reaching a desired state by the person of interest based upon the at least one state in the history of the person of interest.

24. The method of claim 11, wherein storing includes storing the history of the at least one person, wherein the history of the at least one person includes a history of a person of interest, wherein the history of the person of interest includes at least one state, wherein the history of the person of interest includes a plurality of paths, wherein a path includes a sequence of states, and wherein determining the probability of obtaining at least one career outcome or goal includes determining the probability of each path of the plurality of paths for reaching a desired state from a past state.

25. The method of claim 11, wherein storing includes creating a database, and collecting data from at least one database on a network, wherein the at least one database includes at least one résumé.

26. The method of claim 11, wherein storing includes storing the history of the at least one person, wherein the history includes at least one entry in a résumé, wherein the at least one entry includes a state, a start date, and an end date.

27. A data structure for enhancing career analysis, the data structure comprising:
a data member résumés to represent a history of at least one person and to be used to substantially simultaneously determine the probability of obtaining each of a variety of career outcomes or career goals, wherein the data member résumés includes at least one data member state to represent a state in the history of a person, and wherein the at least one data member state includes a plurality of data members, wherein the plurality of data members includes:
an identifier to identify the person;
a begin to represent a beginning date for the state; and
an end to represent an ending date for the state; and
the data structure further including a plurality of data members that represent the probability of obtaining each of a variety of career outcomes or career goals.

28. The data structure of claim 27, wherein a data member identifier uniquely identifies the person.

29. The data structure of claim 28, wherein the at least one data member state further includes a further plurality of data members, wherein the further plurality of data members includes at least one of an activity to represent an activity of the state, a name to represent a name of the person, an institution to represent an institution, an address to represent an address, a gender to represent the gender of the person, a text to represent an original text describing the state, and a latest to represent a last state in the history.

30. The data structure of claim 29, wherein the plurality of data members contains a code, and wherein the code is adapted from the text.

31. The data structure of claim 29, wherein the text is adapted to obtain from a résumé posted on a network.

32. The data structure of claim 29, wherein the network includes a server, wherein the server is accessible through the World Wide Web.

33. The data structure of claim 29, wherein the at least one data member state further includes at least one of a data member nationality to represent a nationality of the person, and a data member hobbies to represent at least one hobby of the person.

34. The data structure of claim 29, further comprising a data member equivalence to represent a codification, wherein the data member equivalence includes a data member code to represent a code, and a data member description to represent a textual description of the code.

35. The data structure of claim 34, wherein the data member equivalence is adapted to be instantiated to form an instantiation for at least one of the data members of the data member state.

36. The data structure of claim 27, wherein the data structure is adapted to be at least one table to be stored in a database.

37. The data structure of claim 35, further comprising a method member query for obtaining a desired state for analysis.

38. The data structure of claim 37, further comprising a method member analyze for analyzing a probability of obtaining at least one consequence for having the desired state.

39. The data structure of claim 38, further comprising a method member sort for sorting each instantiation of the at least one data member state, wherein the data member sort clusters each instantiation of the at least one data member state based on the data member identifier to form at least one cluster, wherein the method member sort sorts the at least one cluster in chronological order based on the data member begin.

40. The data structure of claim 39, further comprising a method member codify for obtaining a code for the desired state, wherein the method member codify obtains the code for the desired state by using at least one of the instantiations of the data member equivalence.

41. The data structure of claim 40, further comprising a method member find for stepping through each instantiation of the at least one data member state in the data member résumés to find an instantiation of the at least one data member state that includes a data member activity that includes a code that matches the code for the desired state, wherein a first instantiation of the at least one data member state that includes a data member activity that includes a code that matches the code for the desired state is defined to be an anchor record, wherein a subsequent instantiation of the at least one data member state that includes a data member activity that includes a code that matches the code for the desired state is defined to be a current record.

42. The data structure of claim 41, further comprising a method member form for forming an instantiation of a temporary data structure, wherein the temporary data structure includes a data member identifier to store a content of the data member identifier of the current record, a data member activity store a content of the data member activity of the current record, a data member begin to store a difference between a content of the data member begin of the current record and a content of the data member begin of the anchor record, a data member end to store a difference between a content of the data member begin of the current record and a content of the data member begin of the anchor record.

43. The data structure of claim 42, further comprising a method member insert for inserting an instantiation of the temporary data structure into an instantiation of a temporaries data structure when the data member identifier of the current record matches the data member identifier of the anchor record, wherein the temporaries data structure includes a collection of the temporary data structures.

44. The data structure of claim 43, when the method member find encounters an instantiation of the at least one data member state that includes a data member activity that includes a code that does not match the code for the desired state but subsequently finds an instantiation of the at least one data member state that includes a data member activity that includes a code that matches the code for the desired state, a subsequent instantiation of the at least one data member state that includes a data member activity that includes a code that matches the code for the desired state is redefined to be the anchor record.

45. The data structure of claim 44, further comprising a method member calculate for calculating a probability for an occurrence of the desired state within a desired time frame based on each instantiation of the temporary data structure.

46. The data structure of claim 45, further comprising a method member graph for producing a graph that graphs the probability of the occurrence of the desired state within the desired time frame.

47. The data structure of claim 46, wherein the desired state includes reaching a profession.

48. The data structure of claim 46, wherein the desired state includes obtaining a compensation level for a profession.

49. The data structure of claim 46, wherein the desired state includes reaching a profession, and wherein the chronological order is backward so as to allow the method member calculate to calculate a distribution of states in the history that lead to the profession.

50. The data structure of claim 46, wherein the desired state includes obtaining a compensation level and reaching a profession, wherein the data structure of claim 46 further comprising a method member compare for comparing the data member institution of each instantiation of the at least one data member state to evaluate the quality of the institution.

51. The data structure of claim 46, wherein the desired state includes a desired population time trend, wherein the data structure of claim 46 further comprising a method member trace for tracing the data member address of each instantiation of the at least one data member state.

52. The data structure of claim 46, wherein the desired state includes a desired consumer population, wherein the data structure of claim 46 further comprising a method member target for analyzing the data member name of each instantiation of the at least one data member state, the data member address of each instantiation of the at least one data member state, the data member hobbies of each instantiation of the at least one data member state so that at least one of a good and a service can be marketed to the desired consumer population.

53. The data structure of claim 46, wherein the desired state includes a plurality of states.

54. The data structure of claim 46, wherein the data member institution of the at least one data member state includes at least one of a data member courses, a data member grades, and a data member average, wherein the data member courses includes at least one course taken by the person, wherein the data member grades includes at least one grade for the at least one course taken by the person, and wherein the data member average includes an average grade for the person.

55. The data structure of claim 46, wherein the graph includes a slider bar.

56. The data structure of claim 46, further comprising a method member assess for assessing the extent to which the data member résumés represents a target population, wherein the method member assess assesses by comparing the data member résumés to data that is known to represent the target population.

57. The data structure of claim 56, further comprising a method member adjust for adjusting the probability for the occurrence of the desired state when the data member résumés is not representative of the target population.

58. The data structure of claim 41, wherein the anchor record includes an anchor date, wherein the anchor date is assigned from one of the data member begin of the instantiation of the at least one data member state that has been defined as the anchor record or the data member end of the instantiation of the at least one data member state that has been defined as the anchor record.

59. The data structure of claim 58, wherein the at least one data member state further includes a data member skill to represent at least one skill of the person, wherein the data member skill includes a code that identifies the skill in the state.

60. The data structure of claim 59, further comprising a method member infer for inferring a date for at least one of the data member begin of the at least one data member state and the data member end of the at least one data member state.

61. The data structure of claim 60, wherein the data member skill of one instantiation of the at least one data member state includes a first desired code, wherein the method member infer forms a first collection of instantiations by collecting each instantiation of the at least one data member state that includes a data member skill that includes a code that matches the first desired code of the data member skill of the one instantiation of the at least one data member state, wherein the data member identifier of the one instantiation of the at least one data member state includes a second desired code, wherein the method member infer forms a second collection of instantiations by collecting each instantiation from the first collection of instantiations that includes a data member identifier that includes a code that matches the second desired code of the data member identifier of the one instantiation of the at least one data member state, wherein the method member infer forms a histogram based on the data member activity of each instantiation of the at least one data member state from the second collection of instantiations, and wherein the method member infer assigns a date for the data member begin of the one instantiation of the at least one data member state from a content of the data member begin of an instantiation of the at least one data member state from the second collection of instantiations that has a highest frequency from the histogram.

62. A method for predicting, the method comprising:
accessing a server through a browser, wherein the server is coupled to the browser through a network, wherein the server includes at least one of a collection of résumés and a collection of transcripts; and
substantially simultaneously predicting a population time trend of a probability of obtaining each of a variety of career outcomes or career goals based on at least one of the collection of résumés and the collection of transcripts, and wherein the population time trend includes a desired state.

63. The method of claim 62, wherein accessing includes accessing through a network that is selected from a group consisting of the Internet and the Internet 2.

64. The method of claim 62, wherein predicting includes predicting the desired state, wherein the desired states includes reaching a profession.

65. The method of claim 62, wherein predicting includes predicting the desired state, wherein the desired state includes obtaining a compensation level for a profession.

66. The method of claim 62, wherein accessing includes forming at least one record, wherein the at least one record includes information that is extracted from the server, wherein predicting includes sorting the at least one record in a chronological order, wherein the desired state includes reaching a profession, and wherein the chronological order is backward so as to allow predicting to predict a distribution of states in the history that lead to the profession.

67. The method of claim 62, wherein accessing includes forming at least one record, wherein the at least one record includes information that is extracted from the server, wherein the information includes an institution, wherein predicting includes comparing each record of the at least one record so the quality of the institution can be evaluated.

68. The method of claim 62, wherein accessing includes forming at least one record, wherein the at least one record includes information that is extracted from the server, wherein the information includes an address, wherein the desired state includes a desired population trend, wherein predicting includes tracing the address of each record to predict a population migration pattern.

69. The method of claim 62, wherein accessing includes forming at least one record, wherein the at least one record includes information that is extracted from the server, wherein the information includes a name, an address, and at least one of a hobby or a skill, wherein the desired state includes a desired consumer population, wherein predicting includes analyzing the name, the address, and the at least one of a hobby and a skill so that at least one of a good and a service can be marketed to the desired consumer population.

70. The method of claim 62, wherein the desired state includes a plurality of states.

71. The method of claim 62, further comprising inferring a date.

72. A method for enhancing career analysis, the method comprising:
storing real or hypothetical career data; and
substantially simultaneously processing the career data to determine the suitability of an individual for each of a variety of career outcomes or career goals based upon the real or hypothetical career data so as to enhance career analysis, wherein the determined probabilities are presented in a consolidated report.
